(19) United States
(12) Patent Application Publication
(10) Pub. No.: US 2001/0048989 A1
(43) Pub. Date: Dec. 6, 2001

(54) Noncombustible insulating duct

(76) Inventor: Kouki Fukui, Takatsuki-shi (JP)

Correspondence Address: WENDEROTH, LIND & PONACK, L.L.P., 2033 K STREET N. W., SUITE 800, WASHINGTON, DC, 20006-1021, US

(21) Appl. No.: 09/870,480

(22) Filed: Jun. 1, 2001

(30) Foreign Application Priority Data
Jun. 2, 2000 (JP) 2000-165442

(51) Int. Cl. B32B 1/08

(52) U.S. Cl. 428/36.1; 428/36.4; 428/36.3

(57) ABSTRACT

A flexible insulating duct excellent in both the noncombustibility and insulating characteristics as well as productivity, and formed by spirally winding a belt-like body which is obtained by wrapping glass wool or some other insulating material with a noncombustible cloth or some other noncombustible sheet type material. When the belt-like body is spirally wound, a preceding end portion thereof and a following end portion thereof are bonded to each other so that the noncombustibility of a final product is not lost, or joined to each other firmly via a noncombustible joint member.

### BACKGROUND OF THE INVENTION

1. Field of the Invention

This invention relates to a noncombustible heat insulating duct having both noncombustibility and insulating characteristics.

2. Description of the Related Art

A duct provided in a building and used for air-conditioning, air discharging and ventilating purposes requires having a noncombustible structure under the Building Standards Act and the Fire Services Act.

A related art noncombustible duct of this kind used in practice is formed by winding glass wool to a predetermined thickness around an outer surface of a spirally wound steel wire or outer surfaces of regularly spaced ring type steel wires, and coating an outer portion of a resultant product with a noncombustible sheet.

Japanese Patent Laid-Open No. 243155/1997 which had opened to the public before the filing date of the application of the present invention discloses a noncombustible insulating duct formed by spirally winding noncombustible insulating fiber, such as glass wool around an outer side of a pipe of a spirally wound steel plate, and coating an outer side of a resultant product with a sheet material.

However, out of these related art noncombustible insulating ducts, the former duct does not necessarily have a high noncombustibility. Moreover, since this duct is formed by winding glass wool around a spirally wound steel wire just as the layer wound around rolled rice of a layer-wound “sushi”, the productivity is low, and a duct of an arbitrary length cannot be freely obtained.

The latter duct disclosed in the patent laid-open publication does not have a flexibility in the spirally wound steel plate pipe, so that this duct has a problem concerning the workability thereof when the duct is drawn around inside a building. In order to obtain a required performance of this duct, it is necessary that the insulating fiber be wound in plural layers. Therefore, this duct also has a low productivity.

### SUMMARY OF THE INVENTION

Therefore, the object of the present invention is to provide a noncombustible insulating duct excellent in both the noncombustibility and insulating characteristics as well as productivity and, moreover, having flexibility.

The present invention also provides a noncombustible insulating duct having flexibility by spirally winding a belt-like body formed by wrapping an insulating material with a noncombustible cloth or some other noncombustible sheet type material. This enables a noncombustible insulating duct capable of being manufactured continuously by using a mandrel, and freely to an arbitrary length to be provided.

The present invention further provides a noncombustible insulating duct excellent in productivity by the structure that an operation for winding insulating fiber in plural layer is not required because the sufficient insulating characteristics is obtained by only a structure that of wrapping with an insulating material such as glass wool.

The present invention also provides a noncombustible insulating duct the flexibility of the whole of which is not lost even when a joint member formed of a metal plate is used, this joint member being merely wound spirally in a longitudinally spaced manner and different from the insulating duct that is wound around a spiral duct body of a steel plate.

The objects of the present invention and the effects obtained by the invention will be clearly understood from the following description given with reference to the drawings.

### BRIEF DESCRIPTION OF THE DRAWINGS

Preferred embodiments of the present invention will be described in detail with reference to the following figures, wherein:

FIG. 1 is a partially sectioned side view of the noncombustible insulating duct according to the present invention;

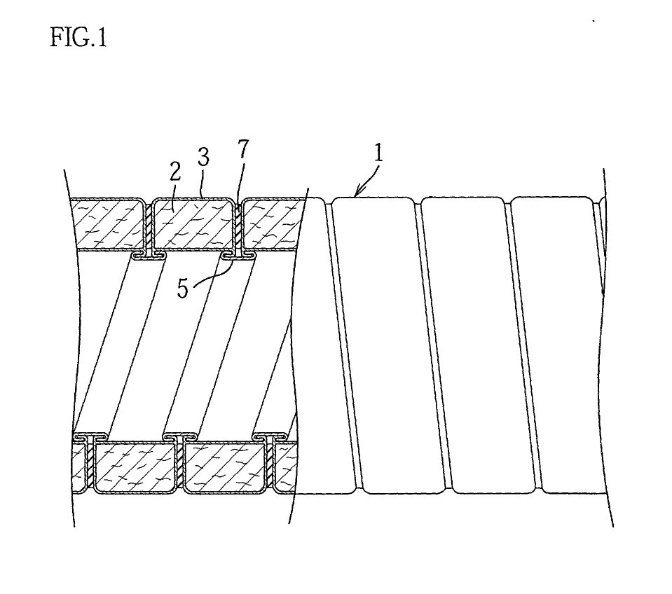

FIG. 2 is an enlarged view of a principal portion of what is shown in FIG. 1;

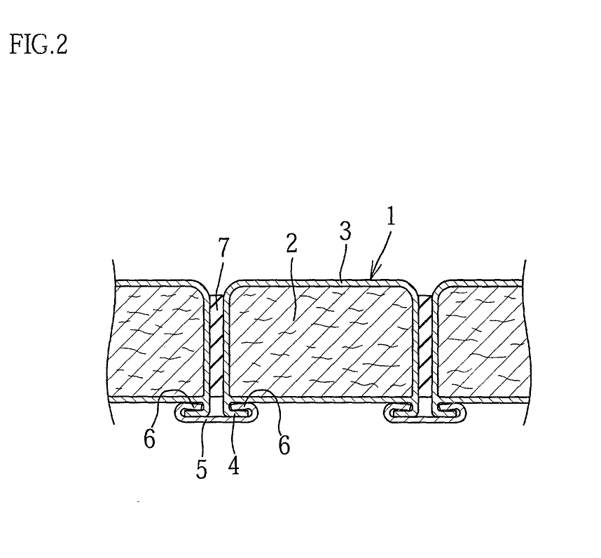

FIG. 3 is a perspective view of a belt-like body; and

FIG. 4 is a partially sectioned side view of a noncombustible insulating duct showing another mode of embodiment of the present invention.

### DESCRIPTION OF THE PREFERRED EMBODIMENTS

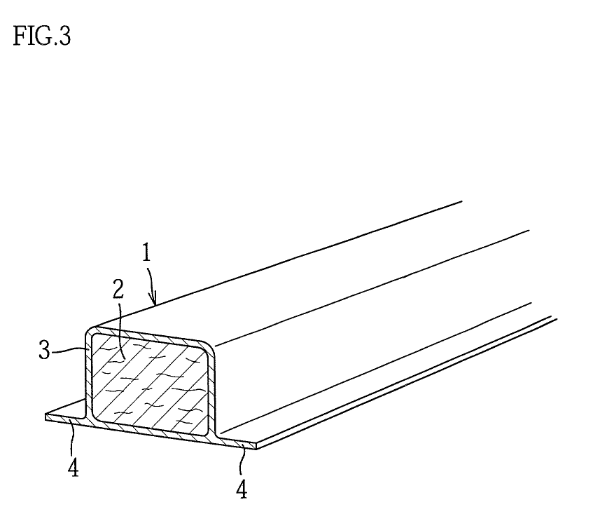

Referring to FIGS. 13, a reference numeral 1 denotes a belt-like body, a product formed as shown in FIG. 3, by coating an outer circumferential portion of an insulating material 2 of, for example, noncombustible glass wool with a noncombustible cloth or some other noncombustible sheet type material 3 in order that a cross section of the belt-like body becomes substantially square. This belt-like body 1 is provided at inner side corners of both of widthwise end portions thereof with flanges 4 which are made integral with and project from the sheet type material 3, and which extend in the longitudinal direction.

A reference numeral 5 denotes a joint member in the present invention, which is formed of a metal plate, for example, a stainless steel plate or some other noncombustible flat plate material. Both of lateral edge portions of this joint member 5 are folded back 6 to the same surface of the joint member so that the joint member has a generally U-shaped cross section. The joint member 5 is wound spirally with the belt-like body 1 so that the surface of the joint member which is on the side of the folded-back portions 6 faces an inner surface of the belt-like body 1.

During this winding operation, a flange 4 at a preceding edge portion of the belt-like body 1 is wound in the inside of one folded-back portion 6, and a flange 4 at a following edge portion of the belt-like body 1 in the inside of the other folded-back portion 6. These folded-back portions are then caulked, and the flanges 4 wound in the inside of the folded-back portions 6 are thereby clamped or embraced. The adjacent end portions of the belt-like body 1 are thus connected together.

In this embodiment, the inner side portions of the belt-like body 1 are connected together by joint members 5 but the outer side portions thereof are not. Therefore, in order to prevent the outer side portions of the belt-like body from being opened and separated, the opposed end portions thereof are bonded to each other with a noncombustible bonding agent 7. In this case, it is also possible to provide the flanges 4 on outer circumferential side of the belt-like body 1, and connect the adjacent end portions of the belt-like body together by using the joint members 5 in the same manner as mentioned above.

The glass wool and rock wool can be named as the insulating member 2 having a noncombustibility, and an aluminum glass cloth, aluminum foil, a nonflammably treated resin film, a glass cloth the pores of which have been filled and coated with a silicon resin, a fire proof processed nonwoven cloth, a nonflammably treated mixed woven cloth, and a mica sheet can be used as the noncombustible sheet material 3. Especially, in the case of a glass cloth, the use of fibers of a large diameter causes the flexibility of the cloth to be lost, and the cloth to be broken when it is bent. Therefore, it is desirable that fibers of a comparatively small diameter be used.

The bonding agent 7 can be formed of, for example, a noncombustible bonding agent using inorganic silicate. Even such a small quantity of organic bonding agent with low noncombustibility that does not cause the noncombustibility of a duct as a whole to be lost can be used.

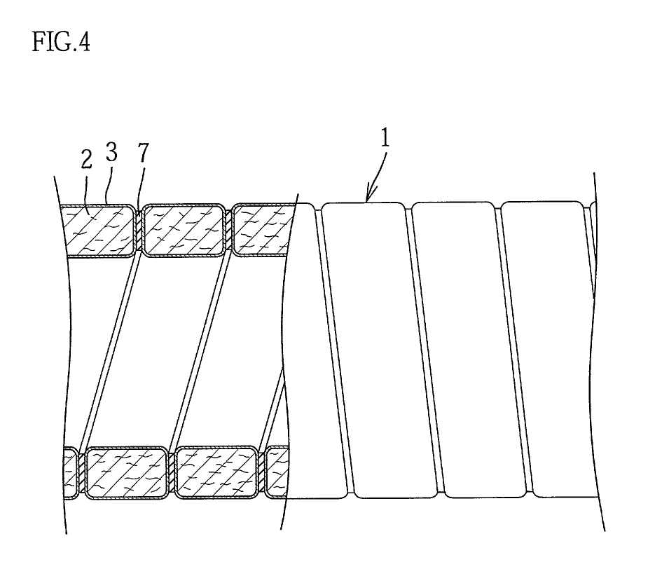

FIG. 4 shows a noncombustible insulating duct formed by connecting adjacent end portions of a belt-like body 1 to each other with only a bonding agent 7 without using joint members 5. In this case, such a small quantity of organic bonding agent that does not cause the noncombustibility of the duct to be lost can also be used but it is desirable that such an inorganic noncombustible bonding agent as mentioned above be used.

The above is a description of a preferred embodiment of the present invention but the present invention is not limited to this embodiment. The present invention can be modified variously within the scope of the following claims, and it should be noted that such modified embodiments are also included in the present invention.

What is claimed is:

1. A noncombustible insulating duct comprising a belt-like body which is formed of an insulating material, such as glass wool, and a noncombustible cloth or some other noncombustible sheet type material with which the insulating material is wrapped, and which is spirally wound, a preceding end portion of the belt-like body and a following end portion thereof being bonded together with a bonding agent in such a manner that the noncombustibility of a final product is not lost.

2. A noncombustible insulating duct according to claim 1, wherein the bonding agent is a noncombustible bonding agent.

3. A noncombustible insulating duct comprising a belt-like body which is formed of an insulating material, such as glass wool, and a noncombustible cloth or some other noncombustible sheet type material with which the insulating material is wrapped, and which is spirally wound, a preceding end portion of the belt-like body and a following end portion thereof being connected together firmly by a noncombustible joint member.

4. A noncombustible insulating duct according to claim 3, wherein a flange projecting from the preceding end portion of the belt-like body and that projecting from the following end portion thereof are wound in folded-back portions at edge sections of the noncombustible joint member and caulked firmly, whereby the end portions of the belt-like body are connected to each other.

5. A noncombustible insulating duct comprising a belt-like body which is formed of an insulating material, such as glass wool, and a noncombustible cloth or some other noncombustible sheet type material with which the insulating material is wrapped, and which is spirally wound, a preceding end portion of the belt-like body and a following end portion thereof being bonded together with a bonding agent in such a manner that the noncombustibility of a final product is not lost, and thereby connected together firmly by a noncombustible joint member.

6. A noncombustible insulating duct according to claim 5, wherein the bonding agent is a noncombustible bonding agent.

7. A noncombustible insulating duct according to claim 5, wherein a flange projecting from the preceding end portion of the belt-like body and that projecting from the following end portion thereof are wound in folded-back portions at edge sections of a noncombustible joint member and caulked firmly, whereby the end portions of the belt-like body are connected to each other.

8. A noncombustible insulating duct according to any one of claims 1-7, wherein the insulating material is noncombustible insulating fiber, such as glass wool and rock wool.
